(19) United States
(12) Patent Application Publication
(10) Pub. No.: US 2011/0191226 A1
(43) Pub. Date: Aug. 4, 2011

(54) INTEGRATED REAL ESTATE MODELING SYSTEM

(75) Inventors: Alan H. Ngo, Charlotte, NC (US); Chris Fromme, Charlotte, NC (US); Stephen Loiko, Mooresville, NC (US)

(73) Assignee: BANK OF AMERICA CORPORATION, Charlotte, NC (US)

(21) Appl. No.: 12/696,786

(22) Filed: Jan. 29, 2010

(51) Int. Cl. G06Q 10/00; G06Q 40/00

(52) U.S. Cl. 705/35; 705/348

(57) ABSTRACT

Embodiments of the invention provide systems, apparatuses, methods, and computer program products configured to estimate the financial costs and savings associated with moving operations and migrating workforce from one site to another. Embodiments of the present invention provide a comprehensive automated financial model of a proposed move of operations by sourcing real estate costs data and labor data pertaining to both the current site and the proposed receiving site from numerous resources and utilizing such data to estimate the costs and savings associated with the move in real time.

### FIELD

In general, this invention relates to systems, apparatuses, methods, and computer program products for modeling real estate business solutions. More particularly, embodiments of the invention provide systems, apparatuses, methods, and computer program products configured to estimate the financial costs and savings associated with office relocation and workforce migration.

### BACKGROUND

Corporations and other organizations are constantly searching for a way to increase their margins by reducing their cost of operation. One common cost-cutting tactic employed by corporations is the relocation and/or integration of certain offices and workforce of the corporation. Relocation can save costs by reducing real estate expenses and facility operational expenses, increasing efficiencies within the workforce which causes a reduction of personnel and consequently a reduction of workforce-associated expenses, and reducing the amount of salaries and benefits paid to employees. In order to determine whether a particular office relocation and workforce migration will result in sufficient cost savings to be worth the expense of the relocation, corporations will often try to predict the financial impact of undertaking the relocation and associated workforce migration.

Current methods utilized in such modeling efforts separately address the two major contributors to overall costs—real estate and labor—and inadequately address the numerous other variables that factor into the effect the possible relocation has on operational costs, including productivity gains, off-shoring and other outsourcing, and flexible work options. Using existing tools, generating the cost and savings estimations is a time-consuming process that relies on data that must be manually obtained from numerous sources and is based on independent determinations regarding the various cost elements (real estate, labor, etc.) that must be later combined together by analysts in order to generate a complete model. In the event that any of the assumptions or variables used in making the estimations changes, the entire process must be restarted in order to account for the new information. Furthermore, current systems have not been equipped to model the financial data of more than one site at a time, a feature that would be highly valuable in situations where there are multiple relocation and restructuring options. Thus, the current methods have a number of inadequacies and inefficiencies that impede corporate decision-makers from being able to swiftly and accurately model office relocation and workforce migration options in order to determine the course of action that will be the most financially beneficial to the corporation.

Accordingly, there is a need for systems, devices, methods, and other tools that allow a corporation to obtain a comprehensive automated model of the financial effect caused by proposed office relocations and workforce migrations in real-time.

### BRIEF SUMMARY

Embodiments of the present invention provide a system for estimating the financial effect of a proposed move of operations from a first site to a second site comprising a user interface, a memory device comprising computer-readable program code and first real estate data relating to the first site, first labor data relating to the first site, second real estate data relating to the second site, and second labor data relating to the second site, and a processor operatively coupled to the user interface and the memory device and configured to execute the computer-readable program code to receive, via the user interface, basic move information comprising an identification of the first site and an identification of the second site, locate in the memory device using the basic move information the first real estate data, the first labor data, the second real estate data, and the second labor data, and utilize at least one of the first real estate data, the first labor data, the second real estate data, and the second labor data to calculate the total estimated cost of undertaking the proposed move, and utilize the first real estate data, the first labor data, the second real estate data, and the second labor data to calculate the estimated savings in cost of operations following the proposed move, wherein the savings are measured over a predefined period of time.

According to some embodiments, the processor is configured to further execute the computer-readable program code to display via the user interface at least one of the total estimated cost, the estimated savings, the payback period, and the internal rate of return. In some embodiments, the first real estate data comprises data relating to the actual cost of operating the first site and the second real estate data comprises data relating to the estimated cost of operating the second site. According to some embodiments, the second real estate data comprises the square footage required at the second site and an estimated per-square foot rate of operation. In some embodiments, the estimated per-square-foot rate is an annual rate and incorporates the estimated annual per-square-foot rent or mortgage payment, utilities expenses, and maintenance expenses. In some embodiments, the first labor data comprises data relating to the cost of the workforce at the first site and wherein the second labor data comprises data relating to the estimated cost of the workforce at the second site. According to some embodiments, the second labor data comprises an estimate of the headcount required at the second site and an estimated per-person cost of labor.

According to some embodiments, the estimated per-person cost of labor is an annual cost and incorporates the estimated average annual salary of employees at the second site and the estimated average annual cost of employee benefits at the second site. In some embodiments, the first real estate data comprises the decommissioning cost for the first site and the lease write-off for the first site and the second real estate data comprises the fit out cost for the second site. According to some embodiments, the first labor data comprises the severance costs for workforce at the first site and the second labor data comprises the hiring, training, and temporary staffing costs for workforce at the second site. According to some embodiments, at least a portion of one of the first real estate data, the first labor data, the second real estate data, and the second labor data was manually entered into the system via the user interface.

In some embodiments, the processor is further configured to execute the computer-readable program code to assign to the basic move information a move identification, and link the move identification to the first real estate data, the first labor data, the second real estate data, and the second labor data. According to some embodiments, the system also comprises a network interface and the processor is further configured to execute the computer-readable program code to obtain at least a portion of at least one of the first real estate data, the first labor data, the second real estate data, and the second labor data by accessing a data source utilizing the network interface. According to some embodiments, the data source is maintained by the same entity that maintains the system and the data source and the system are in communication via a corporate intranet. In some embodiments, the data source is maintained by a third party and the data source and the system are in communication via the internet. According to some embodiments, the system is configured to be utilized by a user to estimate the combined financial effect of multiple proposed moves.

Embodiments of the present invention also provide a method for estimating the financial effect of a proposed move of operations from a first site to a second site comprising: (1) storing first real estate data, first labor data, second real estate data, and second labor data; (2) storing information relating to the proposed move comprising a first site identification and a second site identification; (3) assigning to the first site identification and the second site identification a move identification; (4) linking the first real estate data, the first labor data, the second real estate data, and the second labor data to the move identification; (5) utilizing at least one of the first real estate data, the first labor data, the second real estate data, and the second labor data to calculate the total estimated cost of undertaking the proposed move; and (6) utilizing the first real estate data, the first labor data, the second real estate data, and the second labor data to calculate the estimated savings in cost of operations following the proposed move, wherein the savings are measured over a predefined period of time.

According to some embodiments, at least a portion of one of the first real estate data, the first labor data, the second real estate data, and the second labor data was provided by a user via a user interface. In some embodiments, at least a portion of one of the first real estate data, the first labor data, the second real estate data, and the second labor data was obtained by a tool interfacing with a data source via a network interface. According to some embodiments, the first real estate data comprises data relating to the actual cost of operating the first site and the second real estate data comprises data relating to the estimated cost of operating the second site. According to some embodiments, the second real estate data comprises the square footage required at the second site and an estimated per-square foot rate of operation. In some embodiments, the estimated per-square-foot rate is an annual rate and incorporates the estimated annual per-square-foot rent or mortgage payment, utilities expenses, and maintenance expenses.

According to some embodiments, the first labor data comprises data relating to the cost of the workforce at the first site and wherein the second labor data comprises data relating to the estimated cost of the workforce at the second site. In some embodiments, the second labor data comprises an estimate of the headcount required at the second site and an estimated per-person cost of labor. In some embodiments, the estimated per-person cost of labor is an annual cost and incorporates the estimated average annual salary of employees at the second site and the estimated average annual cost of employee benefits at the second site. According to some embodiments, the first real estate data comprises the decommissioning cost for the first site and the lease write-off for the first site and the second real estate data comprises the fit out cost for the second site. According to some embodiments, the first labor data comprises the severance costs for workforce at the first site and the second labor data comprises the hiring, training, and temporary staffing costs for workforce at the second site. In some embodiments, the method further includes outputting at least one of the total estimated cost, the estimated savings, the payback period, and the internal rate of return.

Embodiments of the present invention provide a computer program product for estimating the financial effect of a proposed move of operations from a first site to a second site comprising a computer-readable medium having computer-readable program code stored therein, wherein the computer-readable program code comprises: a first code portion configured to store first real estate data, first labor data, second real estate data, and second labor data; a second code portion configured to store proposed move information comprising a first site identification and a second site identification; a third code portion configured to link the first real estate data, the first labor data, the second real estate data, and the second labor data to the proposed move information; a fourth code portion configured to calculate the total estimated cost of undertaking the proposed move using at least one of the first real estate data, the first labor data, the second real estate data, and the second labor data to; and a fifth code portion configured to calculate the estimated savings in cost of operations following the proposed move using the first real estate data, the first labor data, the second real estate data, and the second labor data to, wherein the savings are measured over a predefined period of time. In some embodiments, the computer program product also includes a sixth code portion configured to display via a user interface at least one of the total estimated cost of, the estimated savings, the payback period, and the internal rate of return.

### BRIEF DESCRIPTION OF THE DRAWINGS

Reference will now be made to the accompanying drawings to describe some embodiments of the invention, wherein:

FIG. 1 provides a block diagram of an integrated real estate modeling environment in which the modeling processes of the present invention are carried out, in accordance with one embodiment of the present invention; and

FIGS. 2A and 2B provide a flow diagram illustrating a process whereby an entity utilizes the integrated modeling system of the present invention to model a particular move and determine the costs and cost savings associated with such move, in accordance with an embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

As will be appreciated by one of ordinary skill in the art in view of this disclosure, the present invention may be embodied as a method, system, apparatus, computer program product, or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product comprising a computer-readable medium having computer-usable program code embodied in the medium.

Any suitable computer-readable medium may be utilized, including a computer-readable storage medium and/or a computer-readable signal medium. The computer-readable storage medium may be, for example but not limited to, an electronic, magnetic, optical, electromagnetic, infrared, or semiconductor storage system, apparatus, or device. More specific examples of the computer-readable storage medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device. A computer-readable signal medium may include a propagated data signal with computer program instructions embodied therein, for example, in base band or as part of a carrier wave. Such a propagated signal may take any of a variety of forms, including, but not limited to, electro-magnetic, optical, or any suitable combination thereof. In the context of this document, a computer-readable medium may be any medium that can contain, store, communicate, and/or transport the program for use by or in connection with the instruction execution system, apparatus, or device.

Computer program code for carrying out operations of embodiments of the present invention may be written in an object-oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described below with reference to flowchart illustrations and/or block diagrams of methods, apparatus (systems), and computer program products. It will be understood that each block of the flowchart illustrations, and/or combinations of blocks in the flowchart illustrations, can be implemented by computer program instructions. These computer program instructions may be provided to a processor of a general purpose computer, special purpose computer, or other programmable data processing apparatus to produce a particular machine, such that the instructions, which execute via the processor of the computer or other programmable data processing apparatus, create mechanisms for implementing the functions/acts specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture, including instruction means which implement the function/act specified in the flowchart block(s).

The computer program instructions may also be loaded onto a computer or other programmable data processing apparatus to cause a series of operational steps to be performed on the computer or other programmable apparatus to produce a computer-implemented process, such that the instructions which execute on the computer or other programmable apparatus provide steps for implementing the functions/acts specified in the flowchart block(s). Alternatively, computer program implemented steps or acts may be combined with operator or human implemented steps or acts in order to carry out an embodiment of the invention.

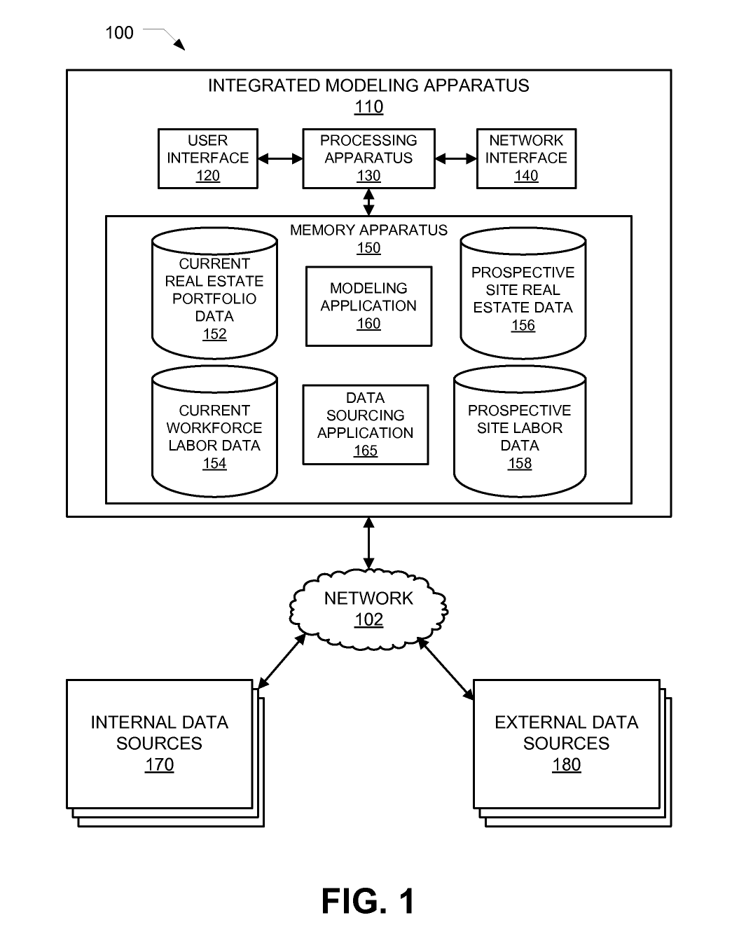

FIG. 1 provides a block diagram of an integrated real estate modeling environment 100, in accordance with one embodiment of the present invention. The integrated real estate modeling environment 100 generally includes an integrated modeling system 110 in communication with one or more internal data sources 170 and one or more external data sources 180 via a network 102. The integrated modeling system 110 comprises a user interface apparatus 120, a network interface apparatus 140, and a memory apparatus 150 operatively coupled to a processing apparatus 130. As described in greater detail below, embodiments of the integrated modeling system 110 are generally configured to model the financial costs associated with real estate solutions that include office relocation and workforce migration and determine the cost savings associated therewith. In this regard, in some embodiments of the invention, the system 110 is owned or maintained by an organization owning or leasing commercial real estate to house its workforce, and the integrated modeling system 110 may, in some embodiments, be integrated with other systems of such organization and may share at least some hardware, software, and/or other resources with such other systems.

As used herein, the term apparatus refers to a device or a combination of devices having the hardware and/or software configured to perform one or more specified functions. Therefore, an apparatus is not necessarily a single device and may, instead, include a plurality of devices that make up the apparatus. The plurality of devices may be directly coupled to one another or may be remote from one another, such as distributed over a network.

It should be understood by one of ordinary skill in the art in view of this disclosure that, although FIG. 1 illustrates the user interface 120, network interface 140, memory apparatus 150, and processing apparatus 130 as separate blocks in the block diagram, these separations may be merely conceptual. In other words, in some instances, the user interface 120, for example, is a separate and distinct device from the processing apparatus 130 and the memory apparatus 150 and therefore may have its own processor, memory, and software. In other instances, however, the user interface 120 is directly coupled to or integral with at least one part of the processing apparatus 130 and at least one part of the memory apparatus 150 and includes the user interface input and output hardware used by the processing apparatus 130 when the processing apparatus 130 executes user input and output software stored in the memory apparatus 150.

As will be described in greater detail below, in one embodiment, the integrated modeling system 110 is entirely contained within a user terminal, such as a personal computer or mobile terminal, while, in other embodiments, the integrated modeling system 110 includes a central computing system, one or more network servers, and one or more user terminals in communication with the central computing system via a network and the one or more network servers. FIG. 1 is intended to cover both types of configurations as well as other configurations that will be apparent to one of ordinary skill in the art in view of this disclosure.

The user interface 120 includes hardware and/or software for receiving input into the integrated modeling system 110 from a user and hardware and/or software for communicating output from the integrated modeling system 110 to a user. In some embodiments, the user interface 120 includes one or more user input devices, such as a keyboard, keypad, mouse, microphone, touch screen, touch pad, controller, and/or the like. In some embodiments, the user interface 120 includes one or more user output devices, such as a display (e.g., a monitor, liquid crystal display, one or more light emitting diodes, etc.), a speaker, a tactile output device, a printer, and/or other sensory devices that can be used to communicate information to a person. In one embodiment, the user interface 120 includes a user terminal, which terminal may be used by an employee of an organization owning or leasing commercial real estate to house its workforce.

In some embodiments, the network interface 140 is configured to receive electronic input from other devices in the network 102, including the internal data sources 170 and the external data sources 180. In some embodiments, the network interface 140 is further configured to send electronic output to other devices in a network. The network 102 may include a direct connection between a plurality of devices, a global area network such as the Internet, a wide area network such as an intranet, a local area network, a wireline network, a wireless network, a virtual private network, other types of networks, and/or a combination of the foregoing.

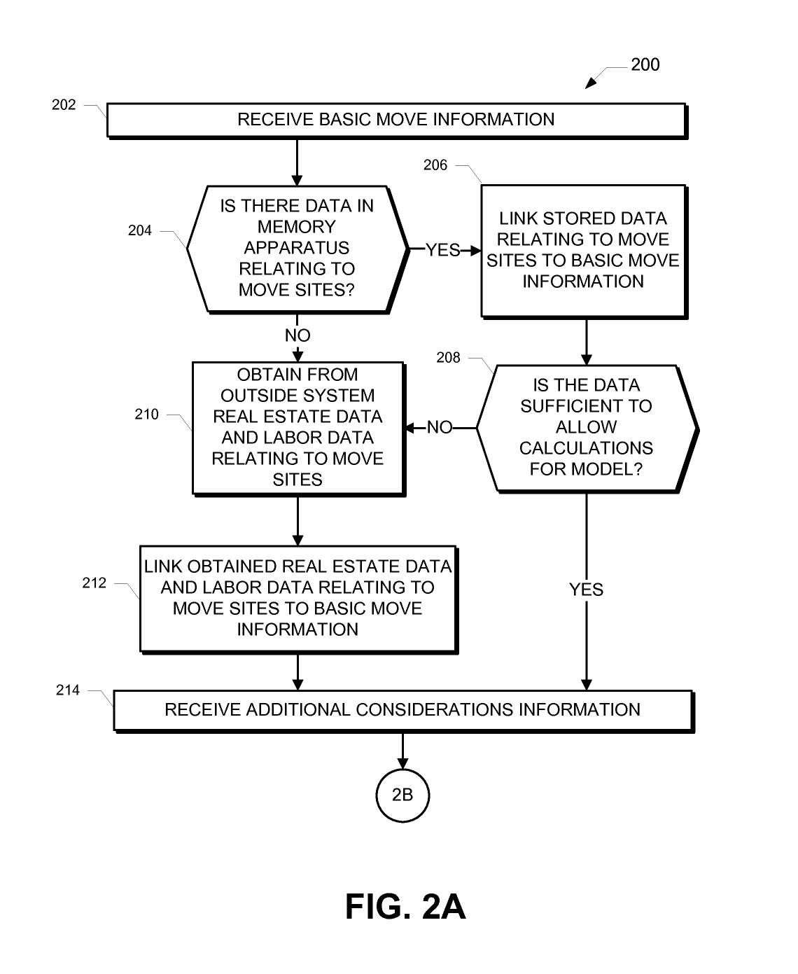

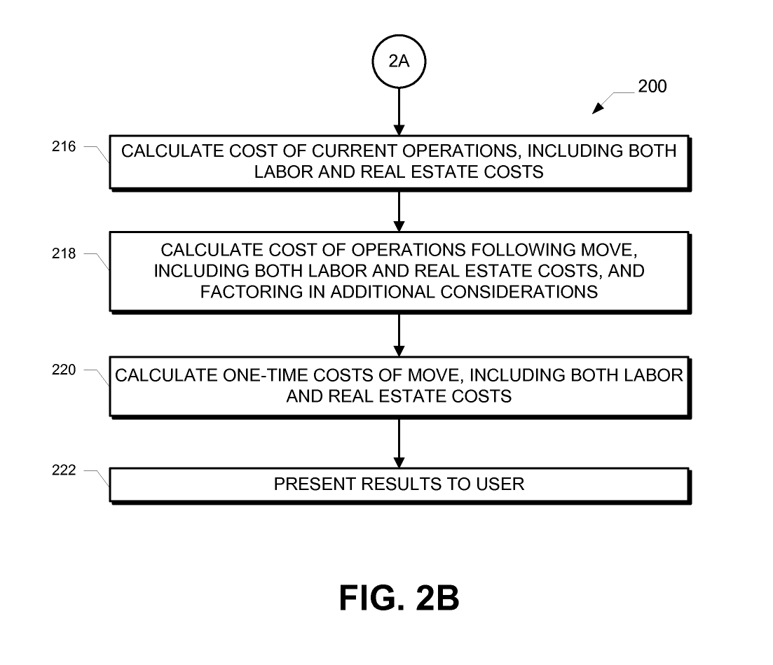

The processing apparatus 130 includes circuitry used for implementing communication and logic functions of the integrated modeling system 110. For example, the processing apparatus 130 may include a digital signal processor device, a microprocessor device, and various analog-to-digital converters, digital-to-analog converters, and other support circuits. Control and signal processing functions of the integrated modeling system 110 are allocated between these devices according to their respective capabilities. The processing apparatus 130 may include functionality to operate one or more software programs based on computer-readable instructions thereof, which may be stored in the memory apparatus 150. As described in greater detail below, in one embodiment of the invention, the memory apparatus 150 includes a modeling application 160 and a data sourcing application 165 stored therein for instructing the processing apparatus 140 to perform one or more operations of the procedures described herein and in reference to FIGS. 2A and 2B. Some embodiments of the invention may include other computer programs stored in the memory apparatus 150.

In general, the memory apparatus 150 is communicatively coupled to the processing apparatus 130 and includes computer-readable storage medium for storing computer-readable program code and instructions, as well as datastores containing data and/or databases. More particularly, the memory apparatus 150 may include volatile memory, such as volatile Random Access Memory (RAM) including a cache area for the temporary storage of data. The memory apparatus 150 may also include non-volatile memory that can be embedded and/or may be removable. The non-volatile memory can, for example, comprise an EEPROM, flash memory, or the like. The memory apparatus 150 can store any of a number of pieces of information and data used by the integrated modeling system 110 to implement the functions of the integrated modeling system 110 described herein.

In the illustrated embodiment, the memory apparatus 150 includes datastores containing current real estate portfolio data 152, current workforce labor data 154, prospective site real estate data 156, and prospective site labor data 158. The current real estate portfolio data 152 generally includes information about commercial real estate currently owned or leased by an entity. In some embodiments, the current real estate portfolio data 152 includes data for all sites owned or leased by the entity. In other embodiments, the current real estate portfolio data 152 includes data only for those sites that are expected to be the subject of a move. As used herein, a “move” will be any workforce organizational solution of an entity that requires a change in the real estate portfolio of the entity and/or a change in the location of a portion of the workforce. The current real estate portfolio data 152 may include, for each site, information such as a site identification, the site's address, square footage, an indication of whether the site is owned or leased, the mortgage terms if owned, the critical lease terms if leased, such as term, rent, etc., the depreciation rate, the anticipated decommissioning expenses, and other information relating to site. The current real estate portfolio data 152 may be received from a user via the user interface 120, or may be obtained through electronic communication with another device, such as the internal data sources 170 or the external data sources 180, via the network 102 and utilizing the network interface 140, and then stored in the memory apparatus 150.

According to some embodiments, the current workforce labor data 154 includes information about current employees of the entity. In some embodiments, the current workforce labor data 154 includes data for all employees of the entity, while in other embodiments, the current workforce labor data 154 includes data only for those employees that will be affected by a move. Linkages may be provided between the current workforce labor data 154 and the current real estate portfolio data 152 such that the labor data for those employees working in a particular site, which data is included in the current workforce labor data 154, is linked to the real estate data for that site, which data is included in the current real estate portfolio data 152. The current workforce labor data 154 may include headcount information, salary information, benefits information, indications of the line of business or job functions of the employees, severance information, and any other information relating to the labor force. The current workforce labor data 154 may be received from a user via the user interface 120, or may be obtained through electronic communication with another device, such as the internal data sources 170 or the external data sources 180, via the network 102 and utilizing the network interface 140, and then stored in the memory apparatus 150.

According to some embodiments, the prospective site real estate data 156 includes information about the intended receiving sites where certain operations of the organization will be located following one or more moves. In some embodiments, the prospective site real estate data 156 includes data for each site that is identified as a potential site to house workforce whose functions are currently performed by workforce at the current site according to a particular relocation/migration proposal. The prospective site real estate data 156 may include a site identification, the address of the site and other location information, the square footage required at the site, approximate cost of the site, including rent or mortgage payments, utilities, water, maintenance, facilities management, etc., estimated one-time cost to fit out the site, and other information relating to the costs associated with the set up and continued operation of the proposed site. The prospective site real estate data 156 may be received from a user via the user interface 120, or may be obtained through electronic communication with another device, such as the internal data sources 170 or the external data sources 180, via the network 102 and utilizing the network interface 140, and then stored in the memory apparatus 150.

According to some embodiments, the prospective site labor data 158 includes information about the workforce that would be assigned to a prospective site following a move. In some embodiments, linkages may be provided between the prospective site labor data 158 and the prospective site real estate data 156 such that the labor data for those employees working in a particular site, which data is included in the current workforce labor data 154, is linked to the real estate data for that site, which data is included in the current real estate portfolio data 152. The prospective site labor data 158 may include the headcount for the prospective site, estimated salary information for the workforce, benefits information, indications of the line of business or job functions of the prospective employees, hiring and training costs for the workforce, and any other information relating to the labor force that will be hired or transferred to populate the new site. The prospective site labor data 158 may be received from a user via the user interface 120, or may be through electronic communication with another device, such as the internal data sources 170 or the external data sources 180, via the network 102 and utilizing the network interface 140, and then stored in the memory apparatus 150.

For the sake of clarity and ease of description, the figures provided herein generally illustrate the current real estate portfolio data 152, current workforce labor data 154, prospective site real estate data 156, and prospective site labor data 158 as each being separate from one another. However, it will be understood that, in some embodiments, these datastores may be combined or the data described as being stored within such datastores may be further separated into additional datastores. For example, in some embodiments, the current real estate portfolio data 152 includes the current workforce labor data 154 for the workforce of the sites contained in the current real estate portfolio data 152. Likewise, the prospective site real estate data 156 may include the prospective site labor data 158. In some embodiments, the current real estate portfolio data 152 and the prospective site real estate data 156 are combined into one datastore and the current workforce labor data 154 and the prospective site labor data 158 are combined into another datastore. In some embodiments, the one-time costs associated with a move are separated into datastores different from those housing data associated with ongoing costs. For example, the one-time costs associated with decommissioning a site and breaking a lease would be separated from the rent and utilities information in the current real estate portfolio data 152 or the one-time costs associated with training and hiring new employees would be separated from the salary and benefits information in the prospective site labor data 158. Each of the foregoing structures is within the scope of the present invention.

In one embodiment, data within each of the four datastores shown in FIG. 1 may be linked to, and thus organized around, a move identification stored in the memory apparatus 150. In such case, unique move identifications are assigned to a particular proposed move. The move identification may be assigned to an overall move, or may be assigned to a portion of a move, such as a particular group of jobs that are being relocated to a particular new site together (even if the particular employees having those jobs are not being transferred pursuant to the move). In either instance, each move corresponds to a current site and one or more prospective sites. Thus, each move identification is linked within the memory apparatus 150 to: (1) real estate data relating to the current site within the current real estate portfolio data 152; (2) labor data relating to the workforce at the current site (the entire workforce if the move identification is assigned to the overall move, or the applicable employees if the move identification is assigned to a particular group of jobs within the overall workforce) within the current workforce labor data 154; (3) real estate data relating to the prospective site(s) within the prospective site real estate data 156; and (4) labor data relating to the replacement or transferred workforce at the prospective site(s) within the prospective site labor data 158. The move identifications may be input by the user via the user interface 120, and may be stored by the processing apparatus 130 in any of the four datastores or in a separate datastore within the memory apparatus 150. Furthermore, the user may also create the linkages in the memory device 150 between the move identification and the data within the four datastores utilizing the user interface 120, as described in detail below.

As further illustrated by FIG. 1, the memory apparatus 150 also includes a modeling application 160 and a data sourcing application 165. As used herein, the term “application” generally refers to computer-readable program code comprising computer-readable instructions and stored on a computer-readable storage medium, where the instructions instruct a processor to perform certain functions, such as logic functions, read and write functions, and/or the like. In this regard, each of the modeling application 160 and data sourcing application 165 includes computer-readable instructions for instructing the processing apparatus 130 and/or other devices to perform one or more of the functions described herein, such as one or more of the functions described in FIGS. 2A and 2B. While the modeling application 160 and data sourcing application 165 are drawn as separate applications within the memory apparatus 150, it should be understood that the functions of the two applications as described herein could be ascribed to a single application or more than two applications.

FIG. 1 further provides one or more internal data sources 170 and one or more external data sources 180 in communication with the integrated modeling system 110 via the network 102. In some embodiments, the internal data sources 170 are databases within the network of computer systems of the entity utilizing the integrated modeling system 110 to model corporate relocations, workforce migrations and other prospective moves. The internal data sources 170 may contain data relevant to the moves, including real estate data and/or labor data. In some embodiments, the internal data sources 170 may be certain databases maintained by the human resources department or the corporate real estate group of the entity. The external data sources 180 likewise contain data relevant to the moves, including real estate and/or labor data, however, the external data sources 180 are not located within the network of computer systems of the entity. In some embodiments, the external data sources 180 are commercial products configured to provide data, including real estate and labor data, to consumers via the internet. In some embodiments, both the internal data sources 170 and the external data sources 180 supply data to be relied upon by the integrated modeling system 110 in order to carry out the various processes described herein.

FIGS. 2A and 2B provides a flow diagram illustrating a process 200 whereby an entity utilizes the integrated modeling system 100 of the present invention to model a particular move and determine the costs and cost savings associated with such move, in accordance with an embodiment of the present invention. While the process 200 illustrated by the flow diagram of FIGS. 2A and 2B is described in the context of a single proposed move, it should be understood that the integrated modeling system 110 is configured to manage the modeling and analysis of multiple proposed moves, and the process 200 can therefore be employed by an entity to contemporaneously assess the costs and benefits of numerous moves.

Referring to FIG. 2A, as represented by block 202, according to some embodiments, the integrated modeling system 100 receives basic move information via the user interface 120 for a particular proposed move. In such instances, the modeling application 160 instructs the processing apparatus 130 to receive the basic move information via the user interface 120 and store the information in the memory apparatus 150. At a minimum, the basic move information includes an identification of a current site from which certain operations will be relocated and an identification of the target site(s) that will receive the relocated operations. In some embodiments, the basic move information further includes information regarding various job groupings that are affected by the move, wherein the jobs within each job grouping will be handled identically with respect to the move, i.e. the jobs within each grouping will be migrated to the same target site. The basic move information may be assigned a unique move identification or “move ID” that will be used to organize all of the data within the memory apparatus 150 of the integrated modeling system 110 that relates to the particular move and/or the sites and workforce involved in the particular move. The basic move information input by the user may include more information, including the real estate data and labor data discussed below, however, it is an object of the present invention that, in some embodiments, the modeling processes implemented by the integrated modeling system 110 will be highly automated and require minimal manual input.

As represented by decision block 204, once the basic move information has been stored in the memory apparatus 150, the modeling application 160 determines whether data is stored in the datastores of the memory apparatus 150 that relates to the sites identified in the basic move information. In particular, the modeling application 160 instructs the processing apparatus 130 to determine whether any of the data within the datastores of the memory apparatus 150 contain data pertaining to either the current site or the targeted site(s). In some embodiments, the processing apparatus 130 attempts to locate real estate data and labor data within the datastores associated with the site identifications that refer to the current site and the target site(s). In the event information is located in the memory apparatus 150 by the processing apparatus 130 that is associated with either the current or target site(s), then, as represented by block 404, the processing apparatus 130 links the responsive data in the memory apparatus 150 to the basic move information that was previously input by the user and stored in the memory apparatus 150. In some embodiments, the responsive data comprises both real estate data and labor data and is linked to the move ID assigned to the particular move and stored in the memory apparatus 150. Alternatively, the responsive data may not be linked to the move ID, but copied to a new datastore within the memory apparatus 150 containing all data relating to the move.

As represented by decision block 208, after related real estate and/or labor data for the site(s) is located and linked to the move ID, a determination must be made as to whether that data is sufficient to render a financial model in accordance with embodiments of the present invention. According to some embodiments, the site data that is required to render a model in accordance with the present invention is all data that affects the total cost of continued operation of the current site and the prospective site(s), including the costs associated with labor, and all data that reflects the one-time costs associated with shutting down the current site and implementing operations at the target site(s). In some embodiments, the modeling application 160 may be configured to prompt the user via the user interface 120 to review the responsive data and determine whether more data is required. This may be advantageous because the data required to render the model may differ for different moves. For example, in a move where the target site is a site that the entity is already operating, there may be no expenses associated with fitting out the new site, thus it would be inaccurate to determine that the data identified in the memory apparatus 150 is insufficient because those expenses are not accounted for. Likewise, in an intra-market move as opposed to an inter-market move, the workforce at the current site may not be terminated and instead transferred to the new site. Thus, the one-time severance costs and hiring and training costs may not factor into the model. For the foregoing reasons, the user of the integrated modeling system 110 may be in the best position to determine whether the data is sufficient, but the determination may be made by the processing apparatus 130 as well, according to instructions provided by the modeling application 160 as to what data is required to render the model.

In some embodiments, the data required to render the model (i.e. the data that affects the total cost of continued operation of the site) includes, for each of the current site and the target site(s), a combination of real estate data and labor data, wherein the real estate data is the square footage of the site and a fully-loaded annual per-square-foot rate, which rate has built into it the rent or mortgage payment, as well as all utilities, water, facilities management costs, maintenance, and other operational costs of the site, and wherein the labor data is the headcount at the site and the actual or estimated salaries of the employees at the site (such salaries may also be fully-loaded to account for benefits, bonuses, etc.). According to different embodiments, the datastores of the memory apparatus 150 may be configured to store the fully-loaded rate and the fully-loaded salary, for example, the fully loaded rate at the target site may be stored in the prospective site real estate data 156, or the modeling application 160 may be configured to instruct the processing device 130 to determine such fully-loaded values using raw data stored in the datastores. For example, the modeling application 160 may be configured to determine the fully-loaded annual per-square-foot rate for either the current site or the target site based on the rent, utilities, maintenance, etc. information stored in the current real estate portfolio data 152 or the prospective site real estate data 156 of the memory apparatus 150, respectively. In one embodiment, only the real estate data and labor data of the prospective site comprises the fully-loaded rate and fully-loaded salary, and the real estate data and labor data of the current site is simply a summation of all actual annual costs attributed to the site. Those skilled in the art will recognize that there are numerous forms that the real estate data and labor data may take in order to generate the total cost of operation of a site in accordance with the present invention. However, as described, in some embodiments, the processing apparatus 130 is configured to determine if the stored real estate and labor data relating to continuing operations of a site is sufficient to generate a fully-loaded rate and a fully-loaded salary and to otherwise calculate total ongoing real estate and labor costs associated with that site.

In addition to the ongoing operational costs data, in order to render an accurate financial model of a move, applicable one-time costs data may also be required. As with the ongoing operational costs data, the one-time costs data may be categorized as either real estate data or labor data. One-time real estate costs may include, for the current site, the accounting write-off that is required for terminating a lease before the end of the term and the decommissioning expenses for the particular facility. Such information, or raw data that may be utilized by the modeling application 160 to determine such information (for example, the lease details and depreciation rate may be used to determine the write-off), may be stored in the current real estate portfolio data 152 or another datastore within the memory apparatus 150 and associated with a particular site identification. Likewise, the one-time real estate costs may include, for the target site(s), the expenses associated with fitting out the facility as well as any broker or other one-time fees. Such information may be stored in the prospective site real estate data 156. With respect to the labor component, the one-time labor costs associated with the current site may include the severance costs, which information (or raw data used to calculate such information) may be stored in the current workforce labor data 154. finally, the one-time labor costs associated with the target site(s) may include hiring and training costs for permanent employees, as well as any temporary or bubble staffing expenses required. According to different embodiments, the processing apparatus 130, in accordance with the instructions of the modeling application 160, or the user, via the user interface 120, determines whether the one-time costs identified in the datastores of the memory apparatus 150 by the processing apparatus 130 as related to the current site or the target site(s) are sufficient to render an accurate financial model in accordance with the present invention.

Referring again to FIG. 2A, in the event the processing apparatus 130 does not locate any responsive data within the datastores of the memory apparatus 150 that is related to the sites identified as the key sites for a particular move in the basic move information, or in the event it locates some responsive data in the datastores but it or a user determines that such data is insufficient to render a complete financial model, then, as represented by block 210, real estate and labor data relating to the sites is obtained from outside of the integrated modeling system 110, stored in the memory apparatus 150, and, as represented by block 212, linked to the basic move information or move ID for the particular move.

In some embodiments, a user of the integrated modeling system 110 provides the needed information via the user interface 120. The modeling application 160 may be configured to instruct the processing apparatus 130 to prompt the user to enter such information via the user interface 120. For example, in the event that the processing apparatus 130 has identified and linked to the move ID complete ongoing operations costs data for the current site, including both real estate data in the current real estate portfolio data 152 and labor data in the current workforce labor data 154, but did not locate any data in the memory apparatus 150 relating to one-time costs or any data relating to the target site at all, the modeling application 160 instructs the processing apparatus 130 to present the located current site data to the user via the user interface 120 as well as prompt the user to enter information relating to the one-time costs and the target site so that the modeling application 160 can render the model for the move. In some embodiments, the user may enter such data utilizing the user interface 120 and the data entered will be stored in the appropriate datastore within the memory apparatus 150 such that it may be used to model future moves. The user may undertake some diligence to determine the data that should be entered (such as anticipated salaries at a target site) and then manually enter it into the integrated modeling system 110. In other embodiments, the user may be able to locate and enter such data through utilizing the data sourcing application 165 to obtain the data via the network 102 from the internal data sources 170 and the external data sources 180, as described below.

According to some embodiments, the modeling application 160 is configured to automatically initialize the data sourcing application 165 to obtain the needed data from the internal data sources 170 and the external data sources 180 once a determination is made that more data is needed to render the model. In such embodiments, the user may be prompted via the user interface 120 to manually enter data only if the efforts of the data sourcing application 165 to retrieve the needed data are unsuccessful. According to some embodiments, the data sourcing application 165 instructs the processing apparatus 130 to use the network interface 140 to reach out to the internal data sources 170 and the external data sources 180 and retrieve the needed data.

For example, in one embodiment, the internal data sources 170 include salary and benefits databases housed in the human resources computer systems accessible via the intranet of the entity. In response to a request from either the user or the modeling application 160, the data sourcing application 165 instructs the processing apparatus 130 to communicate with the human resources computer systems via the network interface 140 in order to query the databases housed therein for salary information pertaining to a particular labor group, whether that group is the entire workforce at a particular site or a portion of that workforce. If there is data responsive to the query, the data is copied and stored by the processing apparatus 130 in the current workforce labor data 154 in the memory apparatus 150, and also linked to the move ID associated with the move for which the data was sought.

As a second example, in one embodiment, the external data sources 180 include an online commercial real estate product that provides estimated rents for particular locations. In response to a request from either the user or the modeling application 160, the data sourcing application 165 instructs the processing apparatus 130 to interface with the online commercial real estate product utilizing the network interface 140 and communicate the location of a target site in order to obtain estimated rent information for such site. In this example, the information obtained will be copied and stored by the processing apparatus 130, according to instructions by the data sourcing application 165, in the prospective site real estate data 156 of the memory apparatus and linked to the move ID associated with the move for which the information was sought. Thus, according to some embodiments, the data sourcing application 165 may be utilized to automatically obtain real estate and labor data from both databases within the computer network of the entity modeling the move, as well as online sources maintained by third parties.

While it has been described that the data sourcing application 165 may be utilized to provide real estate and labor data relating to a particular site or supplement real estate and labor data located in the memory apparatus 150 in the course of modeling a particular move, in some embodiments, the data sourcing application 165 is continuously or periodically updating the datastores of the memory apparatus 150 with data from the internal data sources 170 and external data sources 180. Thus, rather than utilizing the data sourcing application 165 in the context of modeling a particular move, the data sourcing application 165 is a tool employed by the system to populate the datastores with data on the front end before they are accessed during a particular modeling process. In such embodiments, the data sourcing application 165 instructs the processing apparatus 130 to either maintain an open dynamic interface with particular internal data sources 170 and/or external data sources 180 or to periodically query such internal data sources 170 and/or external data sources 180 for real estate and labor data associated with sites or markets associated with the entity or for which data is already stored in the datastores of the memory apparatus 150.

In some embodiments, the data sourcing application 165 may be used both in the foregoing manner, i.e. as a tool that continuously or periodically populates the datastores with updated information about particular sites, and as a tool that is initialized by the user or the modeling application 160 during a particular modeling effort to identify needed data, as described in detail above. The dual functionality of the data sourcing application 165 is particularly helpful in the situation where there is a multitude of data relating to the current site housed in the internal data sources 170 (inasmuch as the entity has been operating the current site for some period of time) but no data or relatively little data in the datastores or internal data sources 170 relating to the target site (inasmuch as the target site is a new site unfamiliar to the entity). In such a situation, the continuous or periodic updating function of the data sourcing application 165 will populate the datastores with data relating to the current site, but would not be configured to obtain data about the target site (unless the data sourcing application 165 were configured to obtain a set of data broader than data related to sites associated with the entity, which would most likely be inefficient). Then, once the target site has been identified by the user inputting the basic move information, the data sourcing application 165 may be used again to locate particular data relating to that site from external data sources 180, such as commercial real estate leasing data from a commercial real estate service.

Referring again to FIG. 2A, according to some embodiments and as represented by block 214, once all real estate data and labor data, including continuing operational costs data and one-time costs data, necessary to render the financial model that is the object of the present invention, as determined by the user via the user interface 120 or the processing apparatus 130 in accordance with instructions from the modeling application 160, has been linked to the basic move information or move ID within the memory apparatus, the integrated modeling system 110 receives via the user interface 120 certain information that represents additional factors applicable to the move that should be considered in the model. Such additional considerations information may include, for example, the anticipated change in productivity due to the move, the extent of off-shoring, near-shoring, or outsourcing of the functions of the current workforce at the current site following the move to the target site, and the extent to which flexible work options will apply to the workforce at the target site. In one embodiment, the productivity change information is set to a default value of an increase in productivity of 10%, based on the notion that any potential move being proposed will reduce inefficiencies at the current site and with the current workforce. The user of the integrated modeling system 110 can choose the values to be entered as additional considerations based upon the particular manner in which the overall real estate solution arising out of the move is intended to be structured. The modeling application 160 instructs the processing apparatus 130 to receive from the user the chosen additional considerations information and store such information in the memory apparatus for use by the modeling application 160 during modeling. According to different embodiments, the additional considerations information may be entered by the user at any time, including concurrently with the basic move information, and it should be understood that the additional considerations information need not be entered after all of the real estate data and labor data is obtained.

Referring now to FIG. 2B, according to some embodiments and as represented by block 216, once all of the various data associated with a proposed move and the key sites of a proposed move has been input by the user and otherwise identified in the datastores of the memory apparatus 150 and obtained from the internal data sources 170 and external data sources 180 and linked within the memory apparatus to a unique move ID identifying the particular move, the financial modeling of the particular move begins by the modeling application 160 instructing the processing apparatus 130 to access the data stored in the current real estate portfolio data 152 and current workforce labor data 154 in the memory apparatus 150 and linked to the move ID and utilize such data to calculate the annual cost of ongoing operations at the current site. As discussed above, the annual cost of ongoing operations at a current site may be calculated through summation of all individual labor costs (i.e. a summation of all salaries, benefits, bonuses, etc.) and all real estate costs (i.e. rent/mortgage, utilities, water, facilities management, maintenance etc.) if such raw data is stored in the memory apparatus 150, or it may be calculated by first calculating a fully-loaded annual per-square foot rate and a fully-loaded salary based on such raw data and multiplying such values by the square footage of the site and the headcount at the site, respectively. In some embodiments, the fully-loaded real estate rate and fully-loaded salary are already stored in a datastore within the memory apparatus 150, whether they were calculated at an earlier time or were provided in that form by the user or the internal data sources 170, such that the processing apparatus 130 must merely access such rates and the square footage and headcount information in order to perform the calculation. Regardless of the methodology employed by the modeling application 160, which methodology is dependent upon the nature and structure of the datastores within the memory apparatus 150, the processing apparatus 130 accesses the real estate data and labor data stored in the memory apparatus 150 and calculates the total annual cost of operating the site, including the real estate costs and the labor costs.

Next, as represented by block 218, the modeling application 160 instructs the processing apparatus 130 to access the data stored in the prospective site real estate data 156 and prospective site labor data 158 in the memory apparatus 150 and linked to the move ID and utilize such data to calculate the estimated annual cost of ongoing operations following the move. According to some embodiments, such calculation will be based on an estimated fully-loaded real estate rate for the location of the target site and an estimated average fully-loaded salary, which values have been obtained from the user via the user interface 120 or from the internal data sources 170 or external data sources 180 and stored in the prospective site real estate data 156 and prospective site labor data 158 in the memory apparatus 150. As for the square footage of the prospective site and the anticipated headcount at the prospective site, which data is needed to make the calculation, according to different embodiments, the data may be likewise stored in the prospective site real estate data 156 and prospective site labor data 158 in the memory apparatus 150 because it was input directly by the user via the user interface 120, or it may be calculated by the processing apparatus 130 based on other user input. In the latter case, for example, the processing apparatus 130 may determine, based on the square footage and headcount of the current site, the input additional considerations information, including anticipated productivity gains, the anticipated outsourcing or offshoring of job functions, the anticipated level of flexible work, and any pre-defined space needs of the particular line of business that is subject to the move (i.e. the number of square feet required by each employee), the square footage and headcount required at the prospective site. The processing apparatus 130 then multiplies these obtained values with the fully-loaded real estate rate and fully-loaded salary to obtain the total real estate and labor costs associated with ongoing operations at the prospective site.

Furthermore, in some embodiments, the additional considerations information previously input by the user is accessed in the memory apparatus 150 and utilized by the processing apparatus 130 to alter the calculation of the estimated annual cost of ongoing operations following the move by changing the inputs that go into the calculation. For example, increased anticipated productivity may cause the processing apparatus 130, in accordance with instructions from the modeling application 160, to reduce the anticipated headcount at the prospective site. Likewise, more flexible work positions at the prospective sites will reduce the square footage required at the prospective site. Or, as another example, in the event the user has entered additional considerations information that indicates that certain job functions will be outsourced or moved offshore following the move, the processing apparatus 130 may be configured to alter the estimated average fully-loaded salary to account for the change in location and consistency of the workforce. In other embodiments, the method of the calculation of the cost may be altered based on the additional considerations information or the output of the calculation may be adjusted based on the additional considerations information. In some embodiments, there is a datastore in the memory apparatus 150 that contains estimated costs associated with outsourcing, nearshoring, and offshoring, which costs may include salary information for such positions. In some embodiments, the outsourcing, nearshoring and offshoring cost information was input by a user into the integrated modeling system 110 via the user interface 120 at an earlier time and stored by the processing apparatus 130 in the memory apparatus 150. At the time of calculation of the ongoing costs associated with the prospective site, the stored outsourcing, nearshoring and offshoring costs information is assessed and used in combination with the input additional considerations information to determine the cost associated with the particular amount of outsourcing, nearshoring and/or offshoring chosen by the user. That cost will be added into the cost of operations at the prospective site, which cost has been reduced according to the reduced headcount and reduced square footage resulting from the outsourcing, nearshoring and/or offshoring in order to obtain the total cost of ongoing operations following the move. One having ordinary skill in the art will recognize that there are numerous ways to account for the additional considerations information in calculating costs at the prospective site, all of which are within the scope of the present invention.

Referring again to FIG. 2B, as represented by block 220 and according to some embodiments, the modeling application 160 next instructs the processing apparatus 130 to access the one-time costs data stored in the datastores of the memory apparatus 150 and linked to the move ID and utilize such data to calculate the total expense of making the move. As described above, the one-time costs may be either real estate costs or labor costs, including decommissioning and fit out expenses, lease write-offs, severance expenses, temporary staffing expenses, and hiring and training expenses, among other costs that may be incurred in order to effectuate the move. According to instructions by the modeling application 160, the processing apparatus 130 accesses all of the one-time costs linked in the memory apparatus to the move ID and sums such costs to obtain the total cost of undertaking the move.

It should be understood that while FIG. 2B illustrates that the calculations performed by the processing apparatus 130 are sequential, they may be performed simultaneously or in any order other than the order shown in accordance with embodiments of the present invention. Furthermore, certain of the calculations may be combined or performed utilizing alternative methods known by those having skill in the art. All methods of calculation and orders of calculation that utilize the data stored in the memory apparatus 150 to generate the final result of total cost of current operations, total cost of operations following the move, and total one-time expense of the move are within the scope of the present invention.

Finally, as represented by block 222, the modeling application 160 instructs the processing apparatus 130 to display the results via the user interface 120. In some embodiments, the results that may be displayed include the total cost associated with the move, the annual savings as determined by the difference between the ongoing operational costs prior to the move and the ongoing operational costs following the move, the “payback period” (meaning the time that it will take to recoup the total cost of the move based on the annual savings), the internal rate of return where the total cost of the move is the initial investment and the annual savings are the payouts, and any other metrics based on the difference in cost of ongoing operations following the move and the one-time cost associated with implementing the move or other metrics that would be valuable to a decision-maker evaluating the benefits of a proposed move. In some embodiments, the modeling application 160 is configured to instruct the processing apparatus 130 to present to the user via the user interface 120 the option of selecting from a number of different outputs from the modeling application 160 to view, including the total cost, payback period, and IRR as described above, and to display such outputs to the user only upon receiving an indication of the user's selection via the user interface 120.

The user of the integrated modeling system 110 may be interested in the overall financial effect of more than one proposed move, for example, in the event multiple moves involving various sites are part of the same overall project, or in the event a move involving one current site involves the job functions of the current site being moved to a number of target sites and thus multiple move IDs were assigned within the integrated modeling system 110. In either instance, according to some embodiments of the present invention, the modeling application 160, in response to a request by the user via the user interface 120, is configured to combine the costs data calculated by the modeling application 160 for multiple move IDs for the purposes of analyzing the moves when taken together. In particular, the total cost associated with each individual move is summed, the total annual cost of current operations of each current site is summed, and the total estimated annual cost of operations following the move, taking into consideration the additional factors (such as productivity, offshoring, flexible work, etc.), for each site is summed. These summed cost values can be used to generate the same metrics used in the case of one move. Thus, it is possible to obtain a total cost associated with multiple moves, the annual savings generated by the multiple moves, as well as the payback period and IRR for the multiple moves. This advantageously allows decision-makers to review a complicated reorganization process as a whole, and not piece-by-piece.

In addition to utilizing the integrated modeling system 110 to determine the total financial effect of a proposed business solution, some users may utilize the integrated modeling system 110 of the present invention to model multiple different move options and compare the results to determine the most cost effective solution. In such embodiments, the integrated modeling system 110 is configured to receive input from a user via the user interface 120 regarding multiple different moves, assign move IDs to the moves and various portions thereof, locate and link the appropriate real estate and labor data in the memory apparatus 150 to the move IDs, and then utilize the modeling application 160 to determine the estimated financial effect associated with the move represented by each move ID. The modeling application 160 is further configured, either in response to a request from a user or automatically, to instruct the processing apparatus 130 to display via the user interface 120 a comparison of the financial effect of two or more moves, or two or more overall solutions, where each overall solution comprises a grouping of moves, as discusses above. Thus, corporate planners may find the integrated modeling system 110 of the present invention to be a highly valuable tool in determining the best relocation/migration/reorganization solution to save costs and increase efficiency.

Another advantageous feature of the model of the present invention is that, according to some embodiments, once the underlying cost data for the sites (including both real estate and labor related costs and both ongoing operational costs and one-time costs for each of the foregoing) has been loaded into the memory apparatus 150, whether such data originated with the user and was manually input via the user interface 120 or was copied from the internal data sources 170 or external data sources 180 utilizing the data sourcing application 165 via the network interface 140, the integrated modeling system 110 is configured to operate in real time to automatically present the financial results to the user in response to the user entering the basic move information and additional considerations information. Thus, the user may choose to alter certain assumptions to test the effect that changing certain inputs, such as offshoring, flexible work, etc., have on the overall financial effect of the move. Inasmuch as the inputs are used in performing the calculations that generate the results, as the user alters such inputs to the system, the financial results presented by the system will change in real-time to reflect the updated information. This advantageously allows the user to model varying move solutions in order to optimize the financial gain to the entity arising out of the move.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for estimating the financial effect of a proposed move of operations from a first site to a second site comprising:
a user interface;
a memory device comprising computer-readable program code and first real estate data relating to the first site, first labor data relating to the first site, second real estate data relating to the second site, and second labor data relating to the second site; and
a processor operatively coupled to the user interface and the memory device and configured to execute the computer-readable program code to:
receive, via the user interface, basic move information comprising an identification of the first site and an identification of the second site;
locate in the memory device using the basic move information the first real estate data, the first labor data, the second real estate data, and the second labor data;
utilize at least one of the first real estate data, the first labor data, the second real estate data, and the second labor data to calculate the total estimated cost of undertaking the proposed move; and
utilize the first real estate data, the first labor data, the second real estate data, and the second labor data to calculate the estimated savings in cost of operations following the proposed move, wherein the savings are measured over a predefined period of time.

2. The system of claim 1, wherein the processor is configured to further execute the computer-readable program code to:
display via the user interface at least one of the total estimated cost, the estimated savings, the payback period, and the internal rate of return.

3. The system of claim 1, wherein the first real estate data comprises data relating to the actual cost of operating the first site and the second real estate data comprises data relating to the estimated cost of operating the second site.

4. The system of claim 3, wherein the second real estate data comprises the square footage required at the second site and an estimated per-square foot rate of operation.

5. The system of claim 4, wherein the estimated per-square-foot rate is an annual rate and incorporates the estimated annual per-square-foot rent or mortgage payment, utilities expenses, and maintenance expenses.

6. The system of claim 1, wherein the first labor data comprises data relating to the cost of the workforce at the first site and wherein the second labor data comprises data relating to the estimated cost of the workforce at the second site.

7. The system of claim 6, wherein the second labor data comprises an estimate of the headcount required at the second site and an estimated per-person cost of labor.

8. The system of claim 7, wherein the estimated per-person cost of labor is an annual cost and incorporates the estimated average annual salary of employees at the second site and the estimated average annual cost of employee benefits at the second site.

9. The system of claim 1, wherein the first real estate data comprises the decommissioning cost for the first site and the lease write-off for the first site and the second real estate data comprises the fit out cost for the second site.

10. The system of claim 1, wherein the first labor data comprises the severance costs for workforce at the first site and the second labor data comprises the hiring, training, and temporary staffing costs for workforce at the second site.

11. The system of claim 1, wherein at least a portion of one of the first real estate data, the first labor data, the second real estate data, and the second labor data was manually entered into the system via the user interface.

12. The system of claim 1, wherein the processor is further configured to execute the computer-readable program code to:
assign to the basic move information a move identification; and
link the move identification to the first real estate data, the first labor data, the second real estate data, and the second labor data.

13. The system of claim 1, further comprising a network interface and wherein the processor is further configured to execute the computer-readable program code to:
obtain at least a portion of at least one of the first real estate data, the first labor data, the second real estate data, and the second labor data by accessing a data source utilizing the network interface.

14. The system of claim 13, wherein the data source is maintained by the same entity that maintains the system and the data source and the system are in communication via a corporate intranet.

15. The system of claim 13, wherein the data source is maintained by a third party and the data source and the system are in communication via the internet.

16. The system of claim 1, wherein the system is configured to be utilized by a user to estimate the combined financial effect of multiple proposed moves.

17. A method for estimating the financial effect of a proposed move of operations from a first site to a second site comprising:
storing first real estate data, first labor data, second real estate data, and second labor data;
storing information relating to the proposed move comprising a first site identification and a second site identification;
assigning to the first site identification and the second site identification a move identification;
linking the first real estate data, the first labor data, the second real estate data, and the second labor data to the move identification;
utilizing at least one of the first real estate data, the first labor data, the second real estate data, and the second labor data to calculate the total estimated cost of undertaking the proposed move; and
utilizing the first real estate data, the first labor data, the second real estate data, and the second labor data to calculate the estimated savings in cost of operations following the proposed move, wherein the savings are measured over a predefined period of time.

18. The method of claim 17, wherein at least a portion of one of the first real estate data, the first labor data, the second real estate data, and the second labor data was provided by a user via a user interface.

19. The method of claim 17, wherein at least a portion of one of the first real estate data, the first labor data, the second real estate data, and the second labor data was obtained by a tool interfacing with a data source via a network interface.

20. The method of claim 17, wherein the first real estate data comprises data relating to the actual cost of operating the first site and the second real estate data comprises data relating to the estimated cost of operating the second site.

21. The method of claim 20, wherein the second real estate data comprises the square footage required at the second site and an estimated per-square foot rate of operation.

22. The method of claim 21, wherein the estimated per-square-foot rate is an annual rate and incorporates the estimated annual per-square-foot rent or mortgage payment, utilities expenses, and maintenance expenses.

23. The method of claim 17, wherein the first labor data comprises data relating to the cost of the workforce at the first site and wherein the second labor data comprises data relating to the estimated cost of the workforce at the second site.

24. The method of claim 23 wherein the second labor data comprises an estimate of the headcount required at the second site and an estimated per-person cost of labor.

25. The method of claim 24, wherein the estimated per-person cost of labor is an annual cost and incorporates the estimated average annual salary of employees at the second site and the estimated average annual cost of employee benefits at the second site.

26. The method of claim 17, wherein the first real estate data comprises the decommissioning cost for the first site and the lease write-off for the first site and the second real estate data comprises the fit out cost for the second site.

27. The method of claim 17, wherein the first labor data comprises the severance costs for workforce at the first site and the second labor data comprises the hiring, training, and temporary staffing costs for workforce at the second site.

28. The method of claim 17, further comprising:
outputting at least one of the total estimated cost, the estimated savings, the payback period, and the internal rate of return.

29. A computer program product for estimating the financial effect of a proposed move of operations from a first site to a second site comprising a computer-readable medium having computer-readable program code stored therein, wherein the computer-readable program code comprises:
a first code portion configured to store first real estate data, first labor data, second real estate data, and second labor data;
a second code portion configured to store proposed move information comprising a first site identification and a second site identification;
a third code portion configured to link the first real estate data, the first labor data, the second real estate data, and the second labor data to the proposed move information;
a fourth code portion configured to calculate the total estimated cost of undertaking the proposed move using at least one of the first real estate data, the first labor data, the second real estate data, and the second labor data to; and
a fifth code portion configured to calculate the estimated savings in cost of operations following the proposed move using the first real estate data, the first labor data, the second real estate data, and the second labor data to, wherein the savings are measured over a predefined period of time.

30. The computer program product of claim 29, further comprising:
a sixth code portion configured to display via a user interface at least one of the total estimated cost of, the estimated savings, the payback period, and the internal rate of return.
